(19) United States
(12) Patent Application Publication
(10) Pub. No.: US 2026/0246218 A1
(43) Pub. Date: Aug. 20, 2026

(54) HAND-ACTUATABLE PLIER TOOL

(71) Applicant: Weidmüller Interface GmbH & Co. KG, Detmold (DE)

(72) Inventors: Ibrahim KUS, Bielefeld (DE); Martin LIMBERG, Herford (DE); Christian HEGGEMANN, Detmold (DE); Rico SCHINDLER, Porta Westfalica (DE); Thilo BRÖKER, Detmold (DE)

(21) Appl. No.: 19/471,254

(22) PCT Filed: Mar. 27, 2024
(86) PCT No.: PCT/EP2024/058221

§ 371 Date: Sep. 30, 2025

(30) Foreign Application Priority Data
Apr. 4, 2023 (DE) 10 2023 108 571.9

(51) Int. Cl. H01R 43/042; B25B 7/14; B25B 7/22

(52) U.S. Cl. CPC H01R 43/0421; B25B 7/14; B25B 7/22

(57) ABSTRACT

A manually operable plier tool includes a first pressing jaw, with a first handle extending therefrom, a second pressing jaw, pivotably mounted on the first pressing jaw, and a second handle, which is movable in a spreadable manner relative to the first handle. The second pressing jaw includes a u-shaped node element with a base and two legs extending from the base, wherein the base of the node element is mounted on the first pressing jaw and a first of the legs is mounted on the second handle. There is also an electronic counter with which the number of treatment or processing operations can be counted and/or stored, wherein the counter has at least one switching element, an evaluating unit and a signal transmitter electrically connected to the evaluating unit. The counter is accommodated in a counting unit releasably fastened on the first pressing jaw, wherein, in the closed position of the plier handles, the second leg of the node element interacts with the counting unit in such a way that at least one counting signal is output to the evaluating unit by the switching element.

### BACKGROUND

The present invention relates to a manually operable plier tool, in particular a manually operable plier tool for processing cables.

In the case of plier tools of this type, it is known to provide electronic counting devices that count the number of actuations performed with the plier tool. Such an electronic counting device is integrated into an auxiliary tool that can be inserted into the plier mouth of the plier tool and that is removed from the plier mouth when not in use, as is disclosed in DE 20 2010 005 761 U1.

Such a plier tool in disclosed in DE 20 2014 105 571 U1, in which an electronic counter is fixed to the rear end of one of the plier handles, so that a counting signal is output to the counter each time the plier handles reach a closed position from a previously spread position.

Such a counter has proven beneficial in practice.

The counting unit installed there is permanently installed in one of the plier handles.

### SUMMARY OF THE DISCLOSURE

It is an object of the present invention to provide a plier tool with a counting unit which can be detachable if required.

It is further an object to provide a manually operable plier tool for processing cables, including a first pressing jaw with a first handle extending from the pressing jaw. The plier tool further includes a second pressing jaw pivotably mounted on the first pressing jaw about a first pivot axis, as well as a second handle which is movable in a spreadable manner relative to the first handle and which is hinged on the second pressing jaw.

A U-shaped node element with a base and two legs extending from the base in the direction of the handles is arranged on the second pressing jaw.

The base of the node element is mounted on the first pressing jaw via the first pivot axis.

A first of the legs of the node element is mounted on the second handle via a second pivot axis.

A second leg of the node element is pivotable in the direction of an upper outer edge of the first pressing jaw remote from the second pressing jaw when a plier mouth formed by the pressing jaws is opened.

The plier tool furthermore has an electronic counter with which the number of treatment or processing operations can be counted and/or stored. The counter has at least one switching element, an evaluating unit and at least one signal transmitter electrically connected to the evaluating unit.

The counter is accommodated in a counting unit detachably fastened to the first pressing jaw, wherein, in the closed position of the plier handles, the second leg of the node element interacts with the counting unit in such a way that at least one counting signal is output to the evaluating unit by the switching element.

A counting unit detachably fastened to the first pressing jaw in this way can be easily attached to the plier tool and also just as easily removed.

The insertion and/or replacement of accessories such as different crimping dies on the plier head of a plier tool formed as crimping pliers is still possible in a simple manner since the counting unit does not engage in the area of the plier mouth.

According to one embodiment, the counting unit has a housing which can be locked to the first pressing jaw and which has a first receiving space for receiving the counter, and a rocker which interacts with the second leg of the node element, for triggering the switching element.

The capacity for the counting unit housing to be locked allows for easy attachment and removal of the counting unit to and from the first pressing jaw.

According to another embodiment, the rocker is received in a second receiving space of the housing and mounted on a rotational axis which divides the rocker into a first rocker leg and a second rocker leg.

This reliably protects the rocker from external access or dirt ingress.

A trigger head for triggering the switching element is formed on a first rocker leg of the rocker. A lug protruding from the housing and interacting with the second leg of the node element is formed on a second rocker leg of the rocker.

Since the second leg of the node element moves when the handles are spread and pressed together, the positioning of the second leg of the node element can advantageously be used to trigger a counting signal.

In yet another embodiment, to prevent an unintentional triggering of such a counting signal, a spring element coupled to the rocker is arranged in the housing, which positions the rocker without external force application such that the trigger head is held resting against the switching element. Only through pivoting the rocker triggered by the movement of the node element is the trigger button moved away from the switching element, as a result of which a counting signal is triggered.

According to a further embodiment, a first locking element for locking onto a first spacer sleeve of the first pressing jaw and a second locking element for locking onto a second spacer sleeve of the first pressing jaw are formed on the housing.

The first locking element is preferably formed as a semi-circular locking recess. The second locking element is formed as an elastic locking lug.

According to a further embodiment still, the at least one signal transmitter of the counter is formed as an optical signal transmitter, in particular as an LED.

The housing furthermore preferably has a window or an opening into which the at least one optical signal transmitter of the counter protrudes.

This enables easy checking of whether a counting signal was triggered when the handles were pressed together.

At least one of the plier handles of the plier tool preferably includes a hand lever and a grip plate at least partially enclosing the hand lever.

The plier tool is preferably formed as crimping pliers or stripping pliers.

According to a further preferred embodiment, in addition to the determination of the number of treatment or processing operations, at least one of the switching elements is formed as a force sensor for determining different strengths of force application during the individual treatment or processing operations. A signal can be output from the force sensor to the evaluating unit, with which the force application of the individual treatment or processing operations can be stored.

### BRIEF DESCRIPTION OF THE DRAWINGS

Preferred exemplary embodiments are explained in greater detail below on the basis of the accompanying drawings. In the drawings:

FIG. 1 is a schematic isometric representation of a manually operable plier tool according to the invention in the closed position,

FIG. 2 is a side view of an embodiment variant of a counting unit according to the invention as an individual representation,

FIG. 3 is a plan view of the counting unit shown in FIG. 2,

FIG. 4 is a side view of the counting unit corresponding to FIG. 2 with half of the housing of the counting unit removed,

FIG. 5 is a side view of the plier tool with spread handles,

FIG. 6 is a representation of the plier tool corresponding to FIG. 5 with plier handles in the closed position and the second leg of the node element resting against the lug of the rocker of the counting unit, and

FIGS. 7 to 9 are representations corresponding to FIGS. 5 and 6 of the plier tool in order to represent the mounting of the counting unit on the first pressing jaw.

### DETAILED DESCRIPTION

In the following description of the figures, terms such as top, bottom, left, right, front, rear, etc. refer exclusively to the exemplary representation and position of the plier tool, the pressing jaw, handle, counting unit, and the like chosen in the respective figures. These terms are not to be understood as limiting, i.e. these references may change due to different working positions, the mirror-symmetrical design or the like.

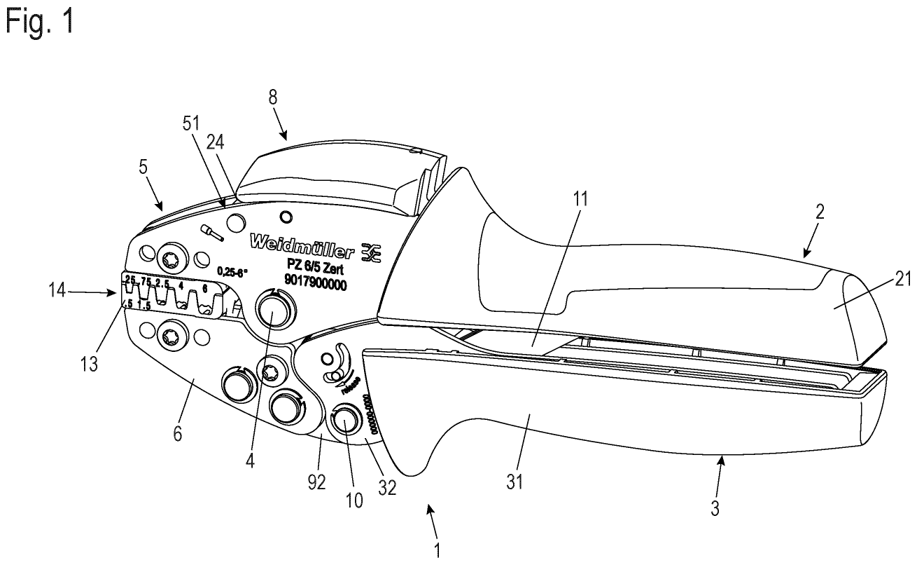

In FIG. 1, there is a manually operable plier tool 1, which is formed here as crimping pliers. However, a formation as stripping pliers is also conceivable.

Such a plier tool 1 has a first pressing jaw 5 with a first handle 2 extending therefrom.

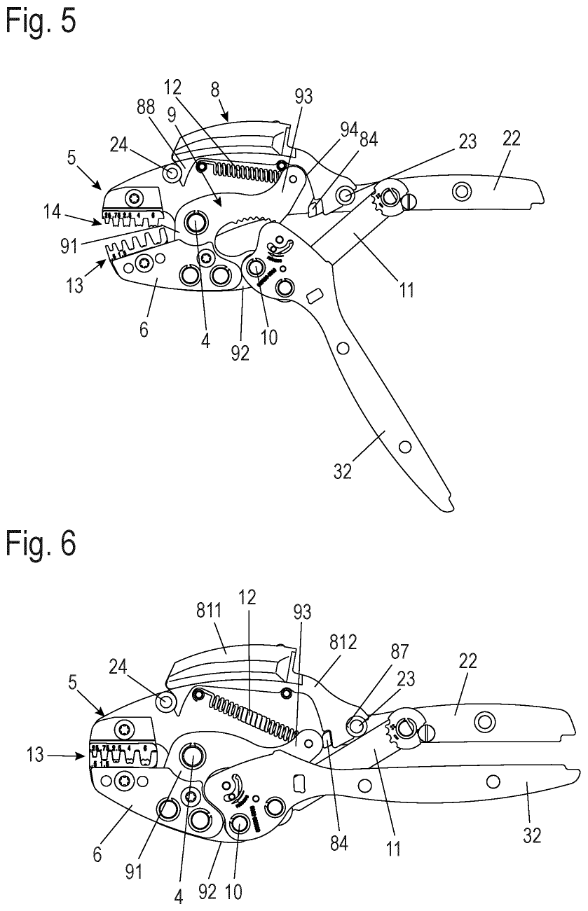

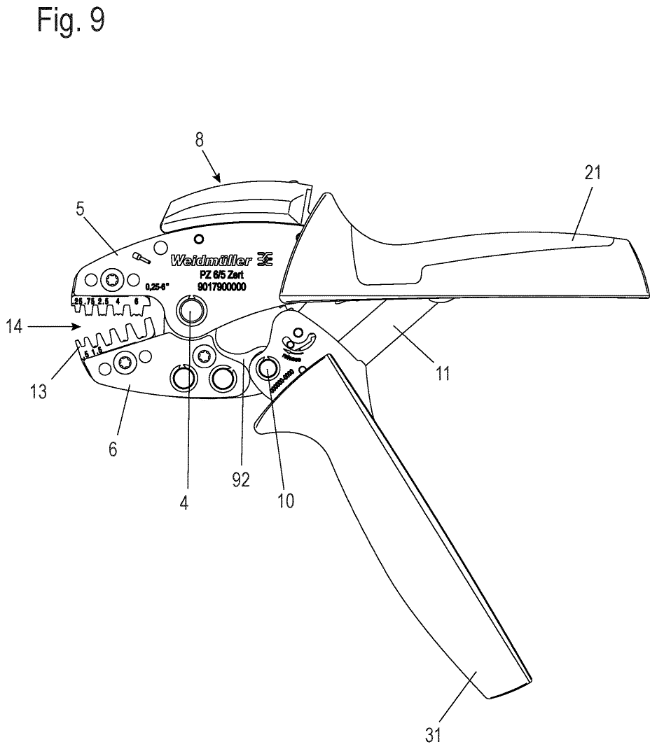

The handle 2 includes a hand lever 22 shown in FIGS. 5 to 8 and a grip plate 21 which at least partially encloses the hand lever 22, as shown in FIGS. 1 and 9.

The hand lever 22 and the first pressing jaw 5 are preferably formed in one piece in the case of the plier tool 1.

The plier tool 1 furthermore has a second pressing jaw 6 pivotably mounted on the first pressing jaw 5 about a first pivot axis 4, as well as a second handle 3 which is movable in a spreadable manner relative to the first handle 2 and hinged on the second pressing jaw 6.

The second handle 3 is also formed from a grip plate 31 and a hand lever 32.

A U-shaped node element 9 with a base 91 and two legs 92, 93 extending from the base 91 in the direction of the handles 2, 3 is arranged in a stationary manner on the second pressing jaw 6.

The base 91 of the node element 9 is mounted on the first pressing jaw 5 via the first pivot axis 4.

A first of the legs 92 of the node element 9 is mounted on the second handle 3 via a second pivot axis 10.

A second leg 93 of the node element 9 is pivotable in the direction of an upper outer edge 51 of the first pressing jaw 5 remote from the second pressing jaw 6 when a plier mouth 14 formed by the pressing jaws 5, 6 is opened, which is shown by comparison in FIGS. 5 and 6.

FIG. 6 shows the plier tool 1 with the plier mouth 14 closed, while FIG. 15 shows the plier tool 1 with the plier mouth 14 open and the handles 2, 3 spread apart.

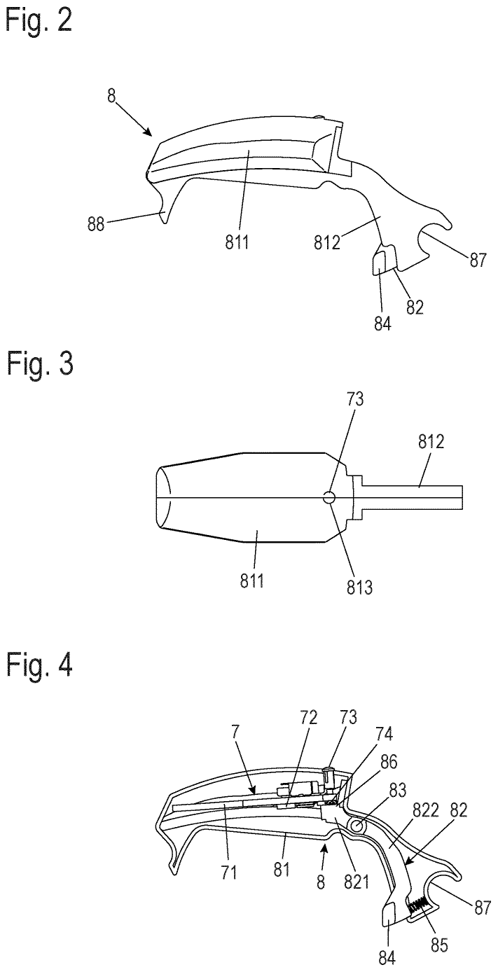

As represented in FIGS. 1 and 7 to 9, a counting unit 8 is detachably fastened to the first pressing jaw 5. Individual representations of this counting unit 8 are shown in FIGS. 2 to 4.

FIGS. 2 and 3 show a housing 81 of this counting unit 8 in a closed state. FIG. 4, on the other hand, shows the counting unit 8 in a side view, in which one half of the housing 81 is removed in order to represent the components accommodated in the housing 81.

At least one electronic counter 7 is accommodated in a first receiving space 811 of the housing 81 of the counting unit 8, with which the number of treatment or processing operations can be counted and/or stored.

The at least one counter 7 has, in addition to a switching element 74, an evaluating unit 72 and at least one signal transmitter 73 electrically connected to the evaluating unit 72. The switching element 74, the evaluating unit 72 and the signal transmitter 73 are preferably fastened on a circuit board 71.

As can be clearly seen in FIG. 6, in the closed position of the plier handles 2, 3, the second leg 93 of the node element 9 interacts with the counting unit 8 in such a way that a counting signal is output from the switching element 74 to the evaluating unit 72.

As shown in FIGS. 4 to 8, the counting unit 8 has a rocker 82, interacting with the second leg 93 of the node element 9, for triggering the switching element 74. This rocker 82 is accommodated in a second receiving space 812 of the housing 81.

The rocker 82 is mounted on a rotational axis 83 and is divided by the rotational axis 83 into a first rocker leg 821 and a second rocker leg 822.

To trigger the switching element 74 of the counter 7, a trigger head 86 is formed on the first rocker leg 821 of the rocker 82, as represented in FIG. 4.

Furthermore, it can be seen in FIG. 4 that a lug 84 protruding from the housing 81 and interacting with the second leg 93 of the node element 9 is formed on the second rocker leg 822 of the rocker 82.

As a comparison, in FIG. 5, the lug 84 protrudes further from the second receiving space 812 when the plier mouth 14 is open and the handles 2, 3 are spread apart (FIG. 5) than in the closed position of the plier tool 1 as shown in FIG. 6, in which an abutment edge 94 on the second leg 93 of the node element 9 presses the lug 84 a little way into the second receiving space 812.

As FIG. 4 further shows, when the second rocker leg 822 of the rocker 82 moves into the second receiving space 812 of the housing 81, the contact between the trigger head 86 at the end of the first rocker leg 821 and the switching element 74 is released, which causes the triggering of a counting signal to the evaluating unit 72 within the counter 7.

In order to pretension the rocker 82 in its neutral position (in which the trigger head 86 rests against the switching element 74), a spring element 85 coupled to the rocker 82 is arranged in the housing 81. The spring element 85 positions the rocker 82 without external force application so that the trigger head 86 rests against the switching element 74.

As shown in FIG. 4, the spring element 85, which is formed here as a compression spring, is arranged in the region of one end of the second receiving space 812 and presses against a rear side of the second rocker leg 822 opposite the lug 84.

It is also conceivable to position this spring element 85 at a different position within the housing 81, for example, below the trigger head 86 on the first rocker leg 821.

In order to pretension the plier tool 1 in its open position, as shown in FIGS. 5, 7, 8 and 9, with the handles 2, 3 spread apart and the plier mouth 14 open, a spring element 12, formed here as a tension spring, is used. It is suspended on the first pressing jaw 5 and on the second leg 93 of the node element 9.

The housing 81 of the counting unit 8 is formed to be lockable to the first pressing jaw 5. For this purpose, a first locking element 87 for locking onto a first spacer sleeve 23 of the first pressing jaw 5 and a second locking element 88 for locking onto a second spacer sleeve 24 of the first pressing jaw 5 are formed on the housing 81.

The first locking element 87 is preferably formed as a semi-circular locking recess which partially encloses the first spacer sleeve 23, as can be seen in FIGS. 5, 6 and 8.

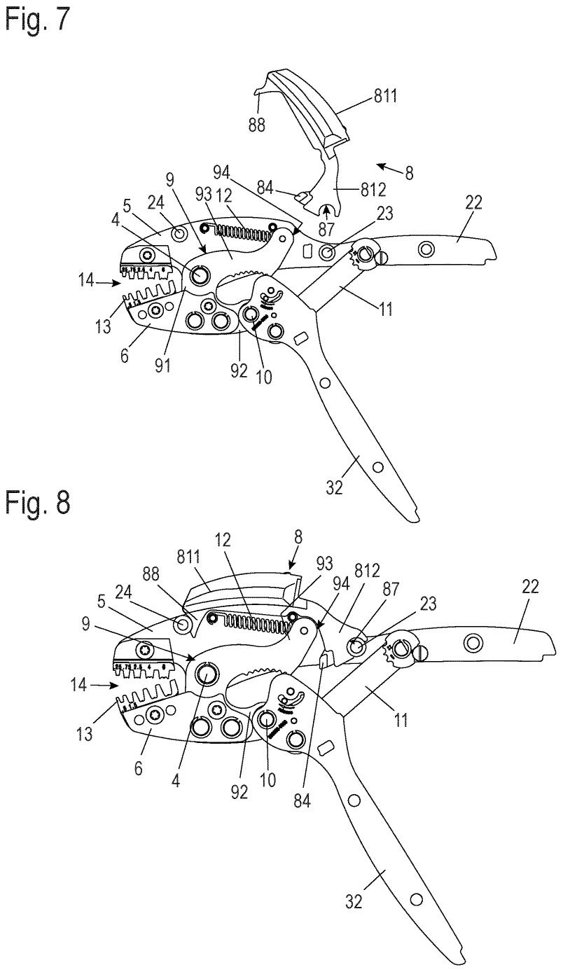

The second locking element 88 is formed here as an elastic locking lug, so that, as can be seen in FIGS. 7 and 8, when mounting the counting unit 8, the first locking element 87 is first placed onto the first spacer sleeve 23.

Subsequently, the housing 81 of the counting unit 8 is pivoted around the first spacer sleeve 23 with the second locking element 88 onto the first pressing jaw 5 and, with slight bending (viewed from the direction of the first spacer sleeve 23), is pressed in front of the second spacer sleeve 24 and thereby locked onto the first pressing jaw 5.

After attaching the counting unit 8 to the first pressing jaw 5, the grip plate 21 of the first handle can finally be placed onto the hand lever 22. A front end of the grip plate 21 engages over the second receiving space 812 of the housing 81 of the counting unit 8.

As can be further seen in FIGS. 3 and 4, the housing 81 has a window or opening 813 into which the optical signal transmitter 73 of the counter 7 protrudes. The signal transmitter 73 of the counter 7 is preferably formed as an optical signal transmitter, in particular as an LED, the activation of which is visible to the outside through the window or opening 813.

In a preferred embodiment variant, at least one of the switching elements 74 is formed as a force sensor for determining different strengths of force application of the individual treatment or processing operations, wherein a signal can be output from the force sensor to the evaluating unit 72, with which the force application of the individual treatment or processing operations, assigned to the individual treatment or processing operations, can be stored.

1. A manually operable plier tool for processing cables, comprising:
a first pressing jaw including a first handle extending therefrom,
a second pressing jaw pivotably mounted on the first pressing jaw about a first pivot axis,
a second handle being spreadably movable relative to the first handle and is being hinged on the second pressing jaw,
a U-shaped node element arranged on the second pressing jaw and having a base and a first and second leg each extending from the base toward the handles,
the base of the node element being mounted on the first pressing jaw via the first pivot axis and the first leg being mounted on the second handle via a second pivot axis,
the second leg of the node element being pivotable toward an upper outer edge of the first pressing jaw remote from the second pressing jaw when a plier mouth is opened,
an electronic counter for counting the number of treatment or processing operations,
the electronic counter having at least one switching element, an evaluating unit and at least one signal transmitter electrically connected to the evaluating unit,
wherein
the counter is arranged in a counting unit detachably fastened to the first pressing jaw, and
the plier handles are in a closed position, the second leg of the node element interacts with the counting unit to output at least one counting signal to the evaluating unit by the at least one switching element.

2. The plier tool according to claim 1, wherein the counting unit includes a housing lockable to the first pressing jaw and having a first receiving space for receiving the counter, a rocker interacts with the second leg of the node element to trigger the switching element.

3. The plier tool according to claim 2, wherein the rocker is mounted in a second receiving space of the housing on a rotational axis dividing the rocker into a first rocker leg and a second rocker leg.

4. The plier tool according to claim 3, wherein a trigger head for triggering the at least one switching element is arranged on the first rocker leg of the rocker and a lug protruding from the housing and interacting with the second leg of the node element is arranged on the second rocker leg of the rocker.

5. The plier tool according to claim 4, wherein a spring element coupled to the rocker is arranged in the housing to position the rocker without external force application such that the trigger head rests against the switching element.

6. The plier tool according to any one of claim 2, wherein the housing includes a first locking element for locking onto a first spacer sleeve of the first pressing jaw and a second locking element for locking onto a second spacer sleeve of the first pressing jaw.

7. The plier tool according to claim 6, characterized in that the first locking element includes a semi-circular locking recess and the second locking element includes an elastic locking lug.

8. The plier tool according to one claim 1, wherein the at least one signal transmitter of the counter includes an optical signal transmitter being an LED.

9. The plier tool according to claim 8, wherein the housing has a window or an opening into which the at least one optical signal transmitter of the counter protrudes.

10. The plier tool according to claim 1, wherein at least one of the plier handles includes a hand lever and a grip plate at least partially enclosing the hand lever.

11. The plier tool according to claim 1, wherein the plier tool is one of crimping pliers, stripping pliers and a cutting tool.

12. The plier tool according to claim 1, wherein at least one of the switching elements includes a force sensor for determining different strengths of force application during individual treatment or processing operations, a signal being output from the force sensor to the evaluating unit to store the force application of the individual treatment or processing operations.
